(19) United States
(12) Patent Application Publication
(10) Pub. No.: US 2019/0051186 A1
(43) Pub. Date: Feb. 14, 2019

(54) ASSESSMENT DEVICE, ASSESSMENT METHOD, AND ASSESSMENT PROGRAM

(71) Applicant: Panasonic Intellectual Property Management Co., Ltd., Osaka (JP)

(72) Inventors: SATOSHI FUKUMOTO, Tokyo (JP); TAKAFUMI TOKUHIRO, Kanagawa (JP); ICHIRO YAMANE, Kanagawa (JP)

(73) Assignee: Panasonic Intellectual Property Management Co., Ltd., Osaka (JP)

(21) Appl. No.: 16/076,455

(22) PCT Filed: Jan. 10, 2017
(86) PCT No.: PCT/JP2017/000381

§ 371 Date: Aug. 8, 2018

(30) Foreign Application Priority Data
Feb. 29, 2016 (JP) 2016-037867

(51) Int. Cl. G08G 1/16; G08G 1/0962

(52) U.S. Cl. CPC G08G 1/167; B60W 30/0956; G08G 1/166; G08G 1/0962

(57) ABSTRACT

A determination device includes: an input unit that receives sensing result information on a moving object on a roadway in a first area, the first area being a sensing range of a sensor for use in a vehicle; and a controller that determines that another moving object safely enters a second area subsequently to the moving object based on the sensing result information when an acceleration of the moving object traveling from the first area to the second area is equal to or more than a first threshold, the second area being outside the sensing range of the sensor.

### TECHNICAL FIELD

The present invention relates to a determination device, a determination method, and a determination program for making a determination regarding travel of a moving object.

### BACKGROUND ART

In recent years, various driving assistance techniques have been developed for assisting drivers of vehicles. For example, there is a technique that assumes that a moving object such as a person will suddenly rush out to a roadway from a blind spot of a parked vehicle, and assists driving of an own vehicle so that the own vehicle can safely pass by the parked vehicle (see, for example, PTL 1).

### CITATION LIST

### Patent Literature

PTL 1: Unexamined Japanese Patent Publication No. 2013-109705

### SUMMARY OF THE INVENTION

A determination device according to an aspect of the present disclosure includes: an input unit that receives sensing result information on a moving object on a roadway in a first area, the first area being a sensing range of a sensor for use in a vehicle; and a controller that determines that another moving object safely enters a second area subsequently to the moving object based on the sensing result information when an acceleration of the moving object traveling from the first area to the second area is equal to or more than a first threshold, the second area being outside the sensing range of the sensor.

A determination method according to an aspect of the present disclosure includes: receiving sensing result information on a moving object on a roadway in a first area, the first area being a sensing range of a sensor for use in a vehicle; and determining that another moving object safely enters a second area subsequently to the moving object based on the sensing result information when an acceleration of the moving object traveling from the first area to the second area is equal to or more than a first threshold, the second area being outside the sensing range of the sensor.

The present disclosure can contribute to safety enhancement in the driving when another moving object is going to enter an entry destination of a vehicle.

### BRIEF DESCRIPTION OF DRAWINGS

FIG. 1 is a block diagram showing an example of configurations of a driving assistance system and a determination device according to an exemplary embodiment of the present invention.

FIG. 2 is a view showing an example of a first area and a second area.

FIG. 3 is a diagram showing an example of a traffic condition when it is determined possible for a vehicle to enter the second area.

FIG. 4 is a view showing an example of a traffic condition when it is determined impossible for the vehicle to enter the second area.

FIG. 5 is a flowchart showing an example of a flow of operations of the determination device according to the exemplary embodiment of the present invention.

FIG. 6 is a view illustrating a first modification of the present invention.

FIG. 7 is a view illustrating a second modification of the present invention.

FIG. 8 is a view illustrating a third modification of the present invention.

FIG. 9 is a diagram showing a hardware configuration of a computer that implements functions of units by programs.

### DESCRIPTION OF EMBODIMENT

Prior to describing an exemplary embodiment of the present invention, problems found in conventional techniques will now briefly be described herein.

The technique mentioned in PTL 1 cannot carry out driving assistance that deals with a case where another moving object (for example, another vehicle) is going to enter an entry destination of a vehicle before the vehicle.

It is an object of the present disclosure to provide a determination device, a determination method, and a determination program for contributing to safety enhancement in driving when another moving object is going to enter the entry destination of the vehicle.

Hereinafter, an exemplary embodiment of the present invention will be described in detail with reference to the drawings. In the exemplary embodiment, like reference numerals are used to designate configurations having identical functions and thus redundant descriptions thereof will be omitted.

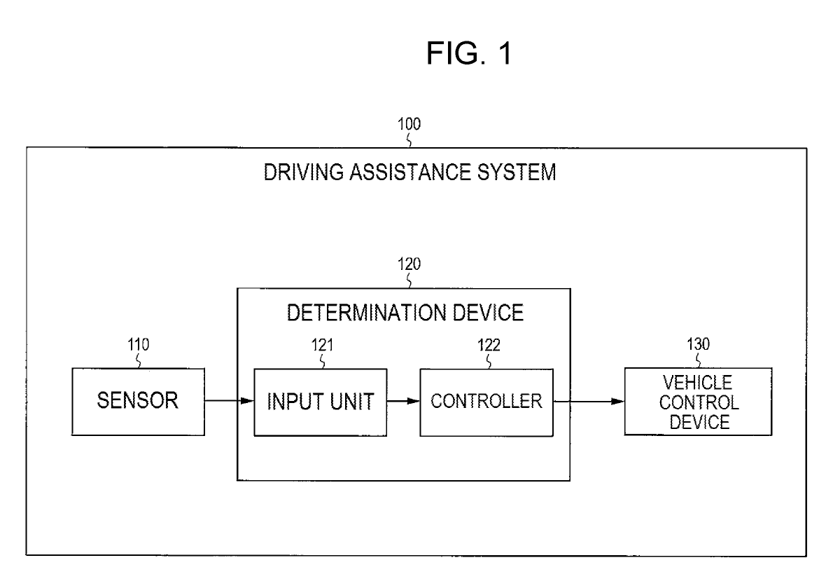

Configurations of driving assistance system 100 and determination device 120 according to the present exemplary embodiment will be described first with reference to FIG. 1. FIG. 1 is a block diagram showing an example of the configurations of driving assistance system 100 and determination device 120 according to the present exemplary embodiment. The present exemplary embodiment is described assuming that driving assistance system 100 is applied to a vehicle.

Driving assistance system 100 includes sensor 110, determination device 120, and vehicle control device 130. Determination device 120 includes input unit 121 and controller 122.

Sensor 110 is a sensor mounted inside or outside a vehicle compartment. Examples of sensor 110 include a sensing camera, a laser range sensor, and a millimeter-wave radar. Sensor 110 senses a moving object (for example, a vehicle, a motorcycle or the like) on a roadway in a preset sensing range (hereinafter, referred to as a first area), and outputs information indicating a result of sensing the moving object (hereinafter, this information is referred to as sensing result information) to input unit 121 of determination device 120. The sensing result information includes at least information on a speed of the moving object. A detection technique of sensor 110 is well-known in the art, and thus a detailed description thereof will be omitted.

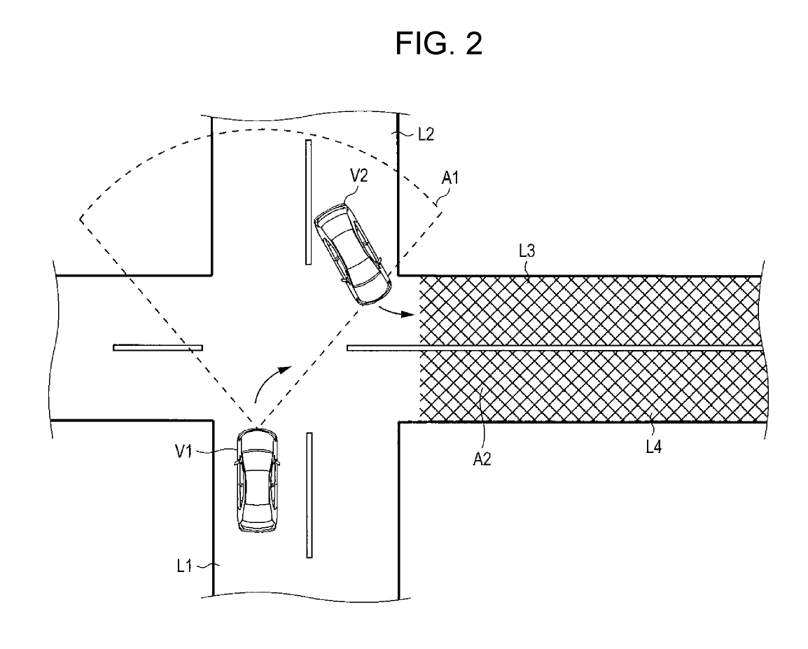

An example of a sensing process performed by sensor 110 will be described with reference to FIG. 2. FIG. 2 is a plan view showing an intersection of a roadway with a single lane on each side when the intersection is seen from directly above.

In FIG. 2, reference symbols L1, L2, L3, and L4 denote lanes. Lane L1 is an opposite lane to lane L2. Lane L3 is an opposite lane to lane L4.

Moreover, reference symbols V1, V2 denote vehicles in FIG. 2. Vehicle V1 is traveling on lane L1, and is going to turn right at the intersection and enter lane L3. Vehicle V2 is traveling on lane L2, and is going to turn left at the intersection and enter lane L3. It is assumed that driving assistance system 100 shown in FIG. 1 is mounted on vehicle V1.

Reference symbol A1 shown in FIG. 2 is an example of the first area. In an example of FIG. 2, the case where first area A1 has a sector shape is taken as an example. However, a shape and size of first area A1 are not limited to those shown in FIG. 2. First area A1 just needs to include at least a range in front of the vehicle.

Reference symbol A2 (hatched portion in FIG. 2) shown in FIG. 2 denotes an example of a range where it is impossible to perform sensing by sensor 110 (hereinafter, this range is referred to as a second area). As shown in FIG. 2, second area A2 is an area including lane L3 and lane L4 for example.

In FIG. 2, sensor 110 mounted on vehicle V1 senses vehicle V2 in which at least a part of a vehicle body is included in first area A1. At this time, a speed of vehicle V2 is sensed for example. Sensor 110 outputs sensing result information about vehicle V2 to input unit 121 of determination device 120. For example, the sensing result information includes information on a speed of vehicle V2. The sensing result information is output at a predetermined interval during a period while vehicle V2 is sensed. In other words, the period is a period while at least a part of vehicle V2 is included in first area A1.

The description has been given above of the example of the sensing process performed by sensor 110. FIG. 1 will be described again below.

Input unit 121 receives the sensing result information from sensor 110, and outputs the sensing result information to controller 122. The present exemplary embodiment is described on the assumption that timing when sensor 110 senses the moving object (for example, vehicle V2) and timing when controller 122 receives the sensing result information are substantially the same.

Upon receiving the sensing result information from input unit 121, controller 122 first calculates an acceleration of the sensed moving object (for example, vehicle V2) based on this sensing result information.

For example, controller 122 receives the sensing result information on vehicle V2 at first timing, and receives the sensing result information on vehicle V2 at second timing later than the first timing. Then, controller 122 calculates the acceleration of vehicle V2 based on the speeds of vehicle V2, which are included in the respective pieces of the sensing result information, and based on a time difference between the first timing and the second timing. The second timing is, for example, timing when a part (front of a vehicle body) of vehicle V2 that has entered lane L3 became included in second area A2 in FIG. 2.

Next, controller 122 determines whether the calculated acceleration is equal to or more than a preset threshold (an example of a first threshold).

When the acceleration is equal to or more than the threshold, controller 122 determines that another moving object (for example, vehicle V1 or a vehicle other than vehicle V1; the same will apply below) can safely enter second area A2 subsequently to the sensed moving object (for example, vehicle V2).

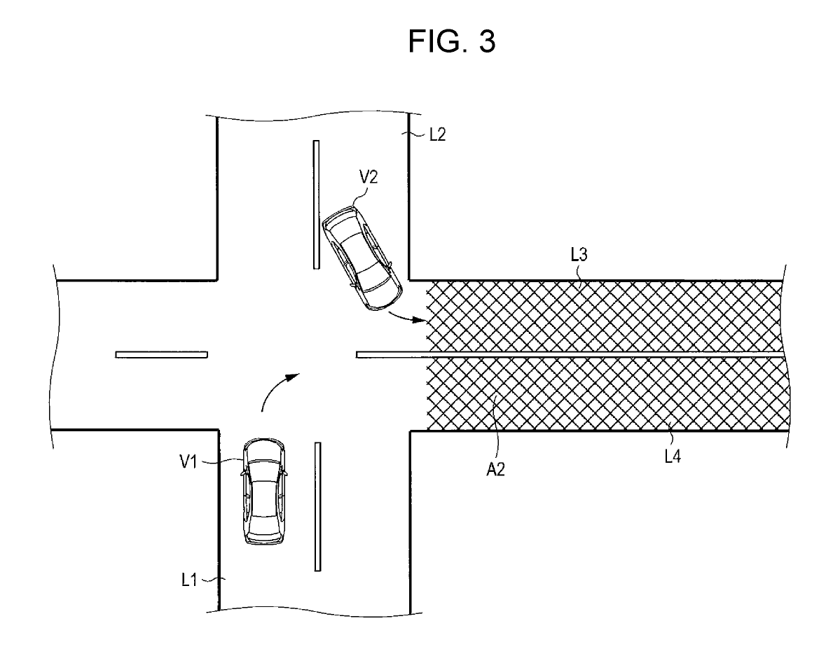

For example, when there is no vehicle remaining on lane L3 as shown in FIG. 3, it is highly possible that vehicle V2 may be going to enter lane L3 at a constant speed without decelerating. An acceleration of vehicle V2 at this time is equal to or more than the threshold. In this case, it is less possible that vehicle V2 that has entered lane L3 may remain on lane L3. Accordingly, it is determined that vehicle V1 can safely enter lane L3 subsequently to vehicle V2.

Meanwhile, when the acceleration is less than the threshold, controller 122 determines that the other moving object (for example, vehicle V1 or the vehicle other than vehicle V1) cannot safely enter second area A2 subsequently to the sensed moving object (for example, vehicle V2).

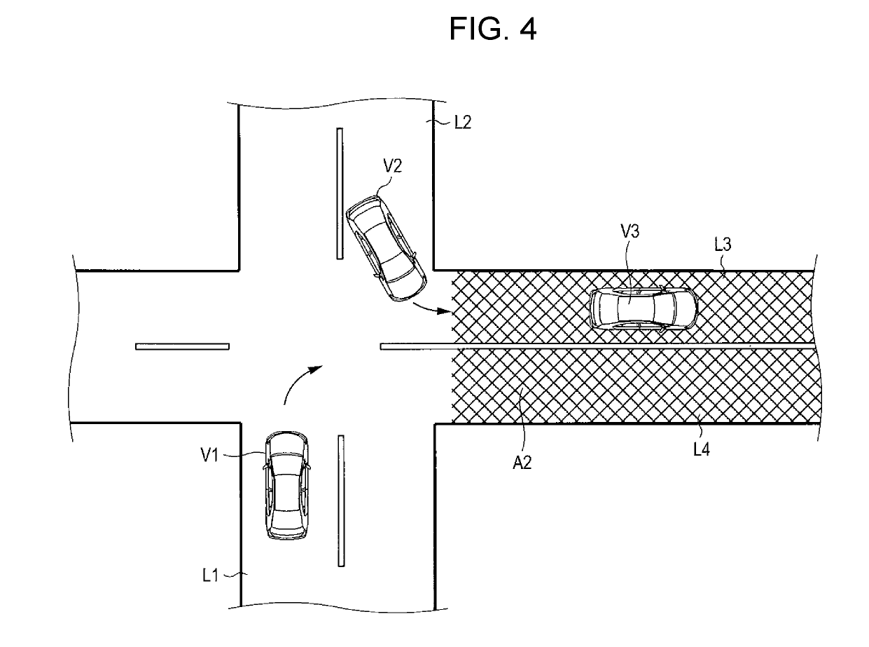

For example, when vehicle V3 remaining on lane L3 is present as shown in FIG. 4, it is highly possible that vehicle V2 may be going to enter lane L3 while slowing down. An acceleration of vehicle V2 at this time is less than the threshold. In this case, it is highly possible that vehicle V2 that has entered lane L3 may remain on lane L3. Accordingly, it is determined that vehicle V1 cannot safely enter lane L3 subsequently to vehicle V2.

Next, to vehicle control device 130, controller 122 outputs determination result information indicating a result of the determination (the result being that vehicle V1 can or cannot safely enter lane L3).

Vehicle control device 130 controls an instrument for use in a vehicle. Examples of the instrument for use in a vehicle include a traveling instrument and a display instrument.

A description will be given of the case where vehicle control device 130 controls the traveling instrument.

For example, when the determination result information indicates that vehicle V1 can safely enter second area A2, vehicle control device 130 outputs a control signal to the traveling instrument to permit the vehicle to travel. Based on the control signal, the traveling instrument controls the vehicle to be permitted to travel. Consequently, the vehicle can travel forward to second area A2.

Meanwhile, for example, when the determination result information indicates that vehicle V1 cannot safely enter second area A2, vehicle control device 130 outputs a control signal to the traveling instrument to prohibit the vehicle from traveling. Based on the control signal, the traveling instrument controls the vehicle to be prohibited from traveling. Consequently, the vehicle cannot travel forward to second area A2.

Next, a description will be given of the case where vehicle control device 130 controls the display instrument.

For example, when the determination result information indicates that vehicle V1 can safely enter second area A2, vehicle control device 130 outputs a control signal to the display instrument to create an image indicating a content of the determination result information. Based on the control signal, the display instrument creates the image indicating that vehicle V1 can safely enter second area A2, and outputs the image to a predetermined display medium. Consequently, an occupant of the vehicle can be informed that vehicle V1 can safely enter second area A2.

Meanwhile, for example, when the determination result information indicates that vehicle V1 cannot safely enter second area A2, vehicle control device 130 outputs a control signal to the display instrument to create an image indicating a content of the determination result information. Based on the control signal, the display instrument creates the image indicating that vehicle V1 cannot safely enter second area A2, and outputs the image to the predetermined display medium. Consequently, the occupant of the vehicle can be informed that the vehicle cannot travel forward to second area A2.

While the above description of controlling the display instrument has been given using output of an image as an example, the present invention is not limited to this case. It is possible to use means that enables the occupant of the vehicle to identify the content of the determination result information (for example, the means is output of a voice, vibration of a seat, or the like).

In addition, the above-mentioned operations of determination device 120 are effective in both automatic driving and manual driving.

The configurations of driving assistance system 100 and determination device 120 have been described above.

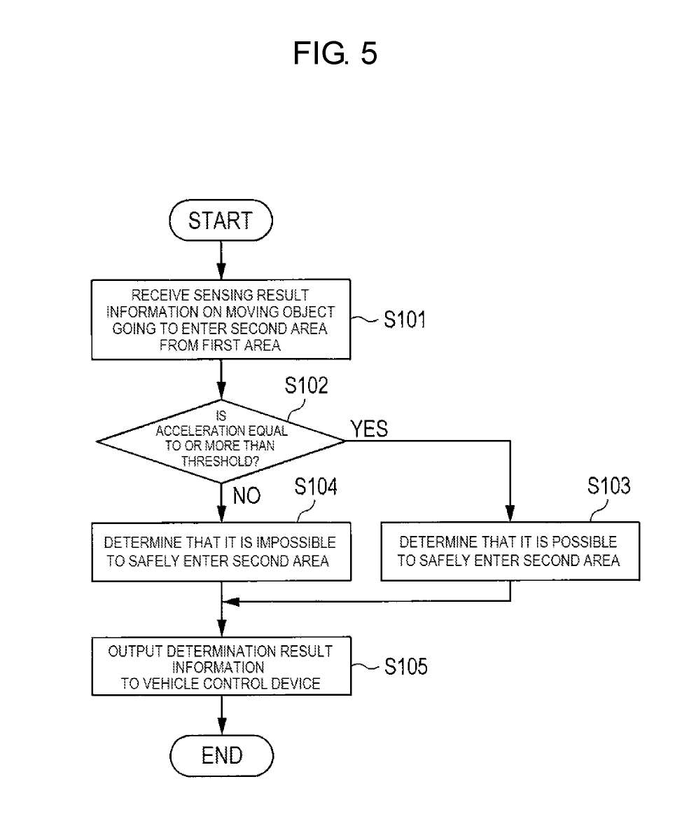

Next, a determination process of determination device 120 is described with reference to FIG. 5. FIG. 5 is a flowchart of a flow of the determination process of determination device 120. For example, this flow is repeatedly performed while the vehicle is traveling.

First, from sensor 110, input unit 121 receives the sensing result information on the moving object that is going to enter second area A2 from first area A1 (step S101). Input unit 121 then outputs the received sensing result information to controller 122.

Next, controller 122 determines whether the acceleration calculated based on the sensing result information received from input unit 121 is equal to or more than the preset threshold (step S102).

When the acceleration is equal to or more than the threshold (step S102: YES), controller 122 determines that the other moving object can safely enter second area A2 subsequently to the sensed moving object (step S103).

Meanwhile, when the acceleration is less than the threshold (step S102: NO), controller 122 determines that the other moving object cannot safely enter second area A2 subsequently to the sensed moving object (step S104).

Next, controller 122 outputs the determination result information to vehicle control device 130 (step S105).

The determination process of determination device 120 has been described above.

In accordance with the exemplary embodiment of the present invention, it is determined whether the vehicle can safely enter second area A2 in response to whether the acceleration of the moving object traveling forward to second area A2 from first area A1 is equal to or more than the threshold. Consequently, the present invention can contribute to the safety enhancement in the driving when the other moving object is going to enter the entry destination of the vehicle.

The present invention should not be limited to the exemplary embodiment described above, and various modifications are possible. The modifications will be described below.

### (First Modification)

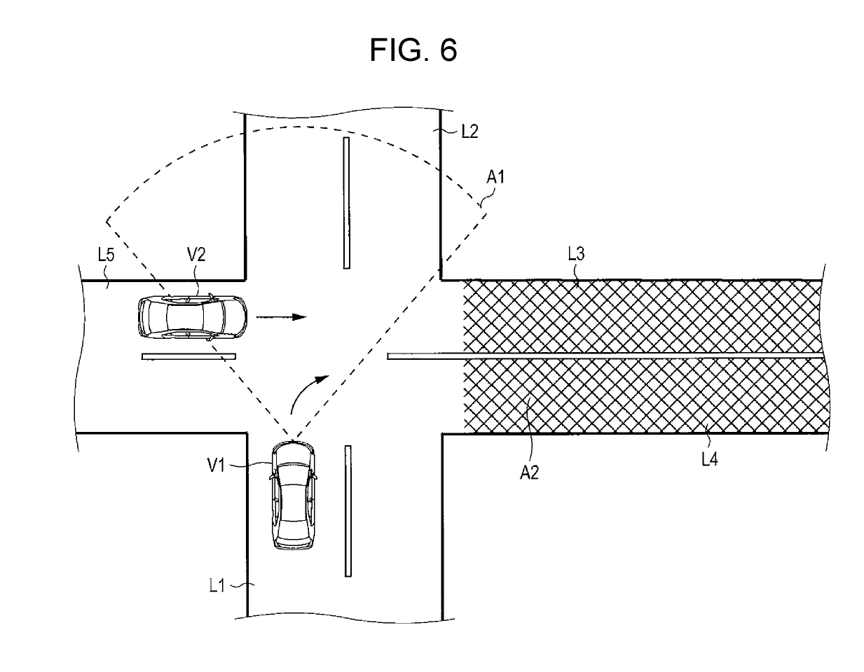

The exemplary embodiment has been described by taking as an example the case where sensed vehicle V2 turns left at the intersection and is going to enter lane L3 (second area A2). However, the present invention is not limited to this. For example, the above-mentioned operations (determination process shown in FIG. 5) of determination device 120 are effective even if vehicle V2 traveling on lane L5 goes straight through the intersection and is going to enter lane L3 (second area A2) as shown in FIG. 6.

### (Second Modification)

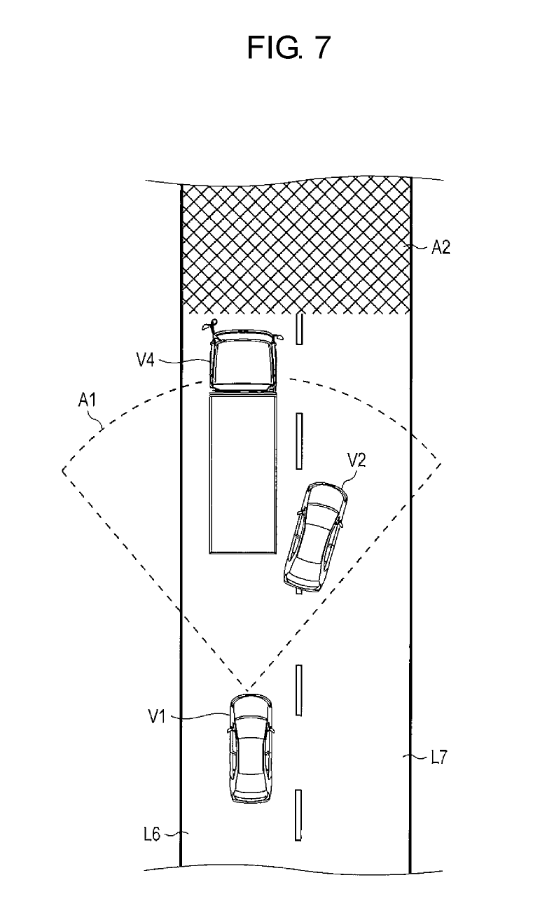

The operations of determination device 120 are also applicable to other than the intersection. An example of this case will be described with reference to FIG. 7. In FIG. 7, lane L6 is an opposite lane to lane L7. Vehicle V4 is a large vehicle such as a truck and a bus. In the example of FIG. 7, second area A2 is an area including lanes L6 and L7 in front of vehicle V4.

In FIG. 7, vehicles V1, V2 are traveling on lane L6, and vehicle V2 is going to overtake vehicle V4 stopping on a road shoulder of lane L6. Even in such a case, determination device 120 can calculate the acceleration of vehicle V2, which is a preceding vehicle to vehicle V1, based on the sensing result information for vehicle V2, and can determine whether vehicle V1 can safely enter second area A2 by comparison between the calculated acceleration and the threshold.

### (Third Modification)

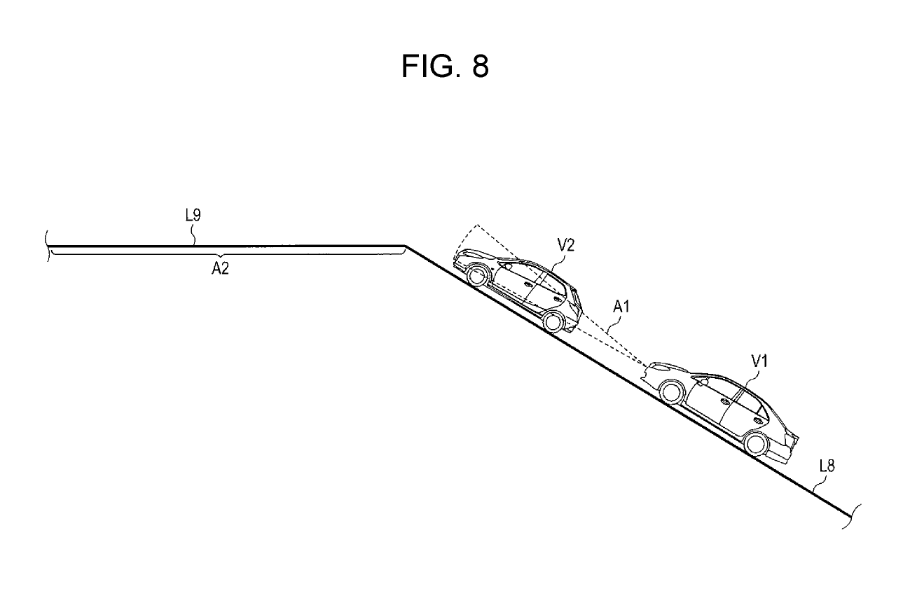

The operations of determination device 120 are also applicable to other than the flat roadway. An example of this case will be described with reference to FIG. 8. In FIG. 8, lane L8 is a slope road, and lane L9 is a flat road connecting to lane L8. In the example of FIG. 8, second area A2 is an area including lanes L9.

In FIG. 8, vehicles V1, V2 are traveling on lane L8. Even in such a case, determination device 120 can calculate the acceleration of vehicle V2, which is a preceding vehicle to vehicle V1, based on the sensing result information for vehicle V2, and can determine whether vehicle V1 can safely enter second area A2 by comparison between the calculated acceleration and the threshold.

### (Fourth Modification)

The exemplary embodiment has been described by taking as an example the case where the moving object to be sensed is only vehicle V2 and where the entry destination of vehicle V1 is the same as the entry destination of vehicle V2. However, it is also possible that a plurality of the moving objects may be sensed, or that entry destinations of the sensed moving objects may be different from the entry destination of vehicle V1. In such a case, it is apprehended that sensing result information unnecessary for the determination process may also be input to determination device 120, and it may take long to do the process. Accordingly, in the present modification, determination device 120 selects those necessary for the determination process from the input sensing result information.

A specific process of the present modification will be described below. In the following description, the moving object (for example, vehicle V2) sensed by sensor 110 is referred to as “sensed vehicle”.

In the present modification, it is assumed that the sensing result information includes information on a traveling direction of the sensed vehicle. For example, sensor 110 senses the traveling direction of the sensed vehicle based on turning on of a direction indicator of the sensed vehicle.

Upon receiving the sensing result information from input unit 121, controller 122 determines whether the traveling direction of the sensed vehicle, which is included in the sensing result information, and the traveling direction of vehicle V1 are the same.

For example, when a traveling route of vehicle V1 is pre-designated by a driver or the like in a navigation system, if the traveling direction of the sensed vehicle is a direction directed to the traveling route thus designated, controller 122 determines that the traveling direction of the sensed vehicle and the traveling direction of vehicle V1 are the same.

Moreover, for example, when the direction indicator of the vehicle is turned on, if the traveling direction of the sensed vehicle is the same as the traveling direction of vehicle V1, which is indicated by the turning on of the direction indicator, controller 122 determines that the traveling direction of the sensed vehicle and the traveling direction of vehicle V1 are the same.

When having determined in this way that the traveling direction of the sensed vehicle and the traveling direction of vehicle V1 are the same, controller 122 selects the sensing result information for the sensed vehicle as the information to be used for the determination process. Then, controller 122 performs the above-mentioned determination process based on the selected sensing result information. Meanwhile, when having determined that the traveling direction of the sensed vehicle and the traveling direction of vehicle V1 are not the same, controller 122 does not use the sensing result information for the sensed vehicle for the determination process.

In accordance with the present modification, the sensing result information necessary for the determination process is narrowed down, thus making it possible to shorten the time taken for the determination process.

### (Fifth Modification)

In the fourth modification, the description has been given of an example of the selection method for the sensing result information by controller 122. The selection method may be a selection method to be described below.

In the present modification, it is assumed that the sensing result information includes information on a position of the sensed vehicle. Moreover, in the present modification, it is assumed that, for example, the traveling route of vehicle V1 is pre-designated by the driver or the like in the navigation system.

Controller 122 first reads out map information from a predetermined storage device. The map information includes information on roadways in a wide area (for example, the information is positions of the respective roadways, junctions of the roadways, and the like).

Next, upon receiving the sensing result information from input unit 121, controller 122 refers to the map information, and determines whether a position of the sensed vehicle, which is included in the sensing result information, is located on a roadway merging into the traveling route of vehicle V1.

When having determined in this way that the position of the sensed vehicle is located on the roadway merging into the traveling route of vehicle V1, controller 122 selects the sensing result information for the sensed vehicle as the information to be used for the determination process. Then, controller 122 performs the above-mentioned determination process based on the selected sensing result information. Meanwhile, when having determined that the position of the sensed vehicle is not located on the roadway merging into the traveling route of vehicle V1, controller 122 does not use the sensing result information for the sensed vehicle for the determination process.

In accordance with the present modification, the sensing result information necessary for the determination process is narrowed down, thus making it possible to shorten the time taken for the determination process.

### (Sixth Modification)

The exemplary embodiment has been described by taking as an example the case of using only the acceleration of the sensed vehicle in the determination process. However, for example, information indicating whether a brake lamp of the sensed vehicle is turned on may be used in addition to the acceleration.

The present modification defines that the sensing result information includes information indicating whether the brake lamp of the sensed vehicle traveling forward to second area A2 is turned on.

Based on the sensing result information received from input unit 121, controller 122 determines whether the acceleration of the sensed vehicle is equal to or more than the threshold, and in addition, determines whether the brake lamp of the sensed vehicle is turned on.

When the acceleration is equal to or more than the threshold and the brake lamp is not turned on as a result of the determination, then controller 122 determines that the other moving object can safely enter second area A2 subsequently to the sensed vehicle.

Meanwhile, when the acceleration is less than the threshold and the brake lamp is turned on as a result of the determination, then controller 122 determines that the other moving object cannot safely enter second area A2 subsequently to the sensed vehicle.

In accordance with the present modification, the information as to whether the brake lamp of the sensed vehicle is turned on is used in addition to the acceleration of the sensed vehicle, whereby a determination with higher accuracy can be implemented.

### (Seventh Modification)

The exemplary embodiment has been described by taking as an example the case of using only the acceleration of the sensed vehicle in the determination process. However, for example, a speed of the sensed vehicle may be used in addition to the acceleration.

As described in the exemplary embodiment, the sensing result information includes the information on the speed of the sensed vehicle traveling forward to second area A2. In the present modification, the threshold for use in making comparison with the acceleration of the sensed vehicle will be referred to as “first threshold”, and the threshold for use in making comparison with the speed of the sensed vehicle will be referred to as “second threshold” (the same will also apply to eighth and ninth modifications to be described later). The second threshold is a value different from the first threshold though is a preset value like the first threshold.

Based on the sensing result information received from input unit 121, controller 122 determines whether the acceleration of the sensed vehicle is equal to or more than the first threshold, and in addition, determines whether the speed of the sensed vehicle is equal to or more than the second threshold.

When the acceleration is equal to or more than the first threshold and the speed is equal to or more than the second threshold as a result of the determination, then controller 122 determines that the other moving object can safely enter second area A2 subsequently to the sensed vehicle.

Meanwhile, when the acceleration is less than the first threshold and the speed is less than the second threshold as a result of the determination, then controller 122 determines that the other moving object cannot safely enter second area A2 subsequently to the sensed vehicle.

In accordance with the present modification, the speed of the sensed vehicle is used in addition to the acceleration of the sensed vehicle, whereby the determination with higher accuracy can be implemented.

### (Eighth Modification)

The seventh modification has been described by taking as an example the case where the second threshold is a preset value. However, the second threshold may be changed in response to an angular velocity of the sensed vehicle.

First, for example, controller 122 calculates the angular velocity of the sensed vehicle based on the sensing result information. Next, controller 122 determines whether the sensed vehicle is traveling straight ahead based on the calculated angular velocity.

When having determined that the sensed vehicle is traveling straight ahead as a result of the determination, controller 122 increases the second threshold (by a predetermined value).

Meanwhile, when having determined that the sensed vehicle is turning right or turning left as a result of the determination, controller 122 reduces the second threshold (by the predetermined value).

Then, using the changed second threshold, controller 122 makes comparison with the speed of the sensed vehicle. The comparison herein has been described in the seventh modification.

In accordance with the present modification, the second threshold is changed in response to the angular velocity, whereby the determination with higher accuracy can be implemented.

### (Ninth Modification)

The seventh modification has been described by taking as an example the case where the first threshold and the second threshold are preset values. However, at least one of the first threshold and the second threshold may be changed in response to a lighting color of a traffic signal.

In the present modification, sensor 110 senses an instruction content of the traffic signal located in the traveling direction of the vehicle, and outputs information indicating the sensed instruction content to input unit 121 of determination device 120. Hereinafter, this information will be referred to as signal information. Input unit 121 then outputs the signal information to controller 122. Hereinafter, the present modification will be described by taking as an example the case where the instruction content of the traffic signal is a lighting color of the traffic signal, which is picked up by sensor 110.

Controller 122 determines the lighting color indicated by the signal information.

In the case where the lighting color is yellow as a result of the determination, controller 122 increases at least one of the first threshold and the second threshold (by a predetermined value).

Meanwhile, in the case where the lighting color is blue as a result of the determination, controller 122 reduces at least one of the first threshold and the second threshold (by the predetermined value).

When having changed the first threshold, controller 122 then makes comparison with the acceleration of the sensed vehicle using the first threshold. The comparison herein has been described in the exemplary embodiment. When having changed the second threshold, controller 122 makes comparison with the speed of the sensed vehicle using the second threshold. The comparison herein has been described in the seventh modification.

In accordance with the present modification, at least one of the first threshold and the second threshold is changed in response to the lighting color of the traffic signal, whereby the determination with higher accuracy can be implemented.

The signal information mentioned above may be transmitted by radio from the traffic signal to determination device 120 (this is an example of a road-to-vehicle communication).

The respective modifications of the present invention have been described above. The respective modifications may be implemented in any combination.

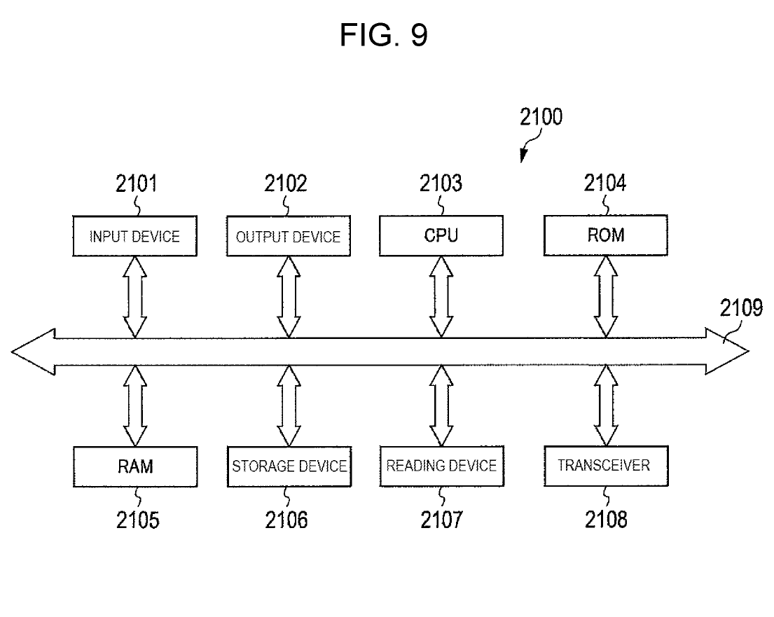

Functions of components in the exemplary embodiment and the modifications may be implemented by programs. FIG. 9 shows an example of a hardware configuration of a computer in such a case.

As shown in FIG. 9, computer 2100 includes: input device 2101 such as input buttons and a touch pad; output device 2102 such as a display and a speaker; central processing unit (CPU) 2103; read only memory (ROM) 2104; and random access memory (RAM) 2105. Computer 2100 further includes: storage device 2106 such as a hard disk device and a solid state drive (SSD); reading device 2107 that reads information from a recording medium such as a digital versatile disk read only memory (DVD-ROM) and a universal serial bus (USB) memory; and transceiver 2108 that performs communication via a network. The respective components are interconnected with bus 2109.

Reading device 2107 reads a program for implementing the functions of the respective components from the recording medium having the program recorded therein, and storage device 2106 stores the program. Alternatively, transceiver 2108 performs communication with a server device connected to the network, and the program for implementing the functions of the respective components, the program having been downloaded from the server device, is stored in storage device 2106.

CPU 2103 then copies the program stored in storage device 2106 on RAM 2105, sequentially reads commands included in the program from RAM 2105, and performs the read commands, whereby the functions of the respective components are implemented. When the program is performed, RAM 2105 or storage device 2106 stores information obtained by the various processes described in the exemplary embodiment and the modifications for appropriate use.

### INDUSTRIAL APPLICABILITY

The determination device, the determination method, and the determination program according to the present invention are useful for the general techniques for determining whether the moving object is capable of traveling under a predetermined condition.

### REFERENCE MARKS IN THE DRAWINGS

100 driving assistance system
110 sensor
120 determination device
121 input unit
122 controller
130 vehicle control device
2101 input device
2102 output device
2103 CPU
2104 ROM
2105 RAM
2106 storage device
2107 reading device
2108 transceiver
2109 bus

1. A determination device comprising:
an input unit that receives sensing result information on a moving object on a roadway in a first area, the first area being a sensing range of a sensor for use in a vehicle; and
a controller that determines that another moving object safely enters a second area subsequently to the moving object based on the sensing result information when an acceleration of the moving object traveling from the first area to the second area is equal to or more than a first threshold, the second area being outside the sensing range of the sensor, the another moving object being the vehicle or a moving object other than the vehicle.

2. The determination device according to claim 1, wherein the controller determines that the other moving object does not safely enter the second area subsequently to the moving object when the acceleration of the moving object is less than the first threshold.

3. The determination device according to claim 1, wherein the controller outputs determination result information indicating a result of the determination to a vehicle control device that controls instrument for use in the vehicle.

4. The determination device according to claim 1, wherein
the sensing result information includes information indicating a traveling direction of the moving object, and
the controller makes the determination based on the sensing result information including the information on the traveling direction identical to a traveling direction of the vehicle.

5. The determination device according to claim 1, wherein
the sensing result information includes information indicating a position of the moving object, and
the controller makes the determination based on the sensing result information including the information on the position of the moving object located on a roadway merging into a traveling route of the vehicle.

6. The determination device according to claim 1, wherein
the sensing result information includes information indicating whether a brake lamp of the moving object traveling to the second area is turned on, and
the controller determines that the other moving object safely enters the second area subsequently to the moving object when the acceleration is equal to or more than the first threshold and the brake lamp is turned off, and determines that the other moving object does not safely enter the second area subsequently to the moving object when the acceleration is less than the first threshold and the brake lamp is turned on.

7. The determination device according to claim 1, wherein
the sensing result information includes information indicating a speed of the moving object traveling to the second area, and
the controller determines that the other moving object safely enters the second area subsequently to the moving object when the acceleration is equal to or more than the first threshold and the speed is equal to or more than a second threshold, and determines that the other moving object does not safely enter the second area subsequently to the moving object when the acceleration is less than the first threshold and the speed is less than the second threshold.

8. The determination device according to claim 7, wherein the controller calculates an angular velocity of the moving object traveling to the second area based on the sensing result information, and changes the second threshold based on the angular velocity.

9. The determination device according to claim 7, wherein
the sensing result information includes signal information indicating a sensing result of an instruction content of a traffic signal located in a traveling direction of the vehicle, and
the controller changes at least one of the first threshold and the second threshold based on the signal information.

10. A determination method comprising:
receiving sensing result information on a moving object on a roadway in a first area, the first area being a sensing range of a sensor for use in a vehicle; and
determining that another moving object safely enters a second area subsequently to the moving object based on the sensing result information when an acceleration of the moving object traveling from the first area to the second area is equal to or more than a first threshold, the second area being outside the sensing range of the sensor, the another moving object being the vehicle or a moving object other than the vehicle.
